(19) United States
(12) Patent Application Publication
(10) Pub. No.: US 2005/0053415 A1
(43) Pub. Date: Mar. 10, 2005

(54) Make-up apparatus for liquid type cosmetics

(76) Inventor: Young Kwang Byun, Seoul (KR)

Correspondence Address: Bell, Boyd & Lloyd LLC, P.O. Box 1135, Chicago, IL, 60690-1135, US

(21) Appl. No.: 10/677,721

(22) Filed: Oct. 1, 2003

(30) Foreign Application Priority Data
Sep. 8, 2003 (KR) 2003-28883

(51) Int. Cl. A47L 13/22; B43K 5/02

(52) U.S. Cl. 401/270; 401/188 R

(57) ABSTRACT

Disclosed is to a make-up apparatus for liquid type cosmetics. The make-up apparatus includes: a body for containing liquid type cosmetics, the body having a diaphragm, in which a hole is formed, and a groove formed in a side surface thereof; a cap mounted on the lower end of the body, the cap having an air circulation hole; a pressurization pump having a push button, a guide part and a push rod, the push button being detachably mounted on the groove of the body, the guide part being formed on an end of the pressurization pump, located inside the body and slidably contacted with the push button, the push rod being located inside the pressurization pump and having a hollow portion for forming a discharge induction tube therein; a spring for providing a restoring force to the push button and the push rod; a discharge valve connected with the push rod, the discharge valve having a spring located between the discharge valve and the push rod, and an open-and-shut mechanism for providing the cosmetics only when the external force is applied to the push button; an injection nozzle for providing the cosmetics, which is discharged through the discharge valve, to a brush through a nozzle; a brush and a brush holder for covering the cosmetics supplied by the injection nozzle onto the user's skin; a front end part for supporting the brush by the brush holder while the brush passes through the front end part, the front end part being mounted on the upper end of the body; and a protection cap coupled with the front end part.

### BACKGROUND OF THE INVENTION

1. Field of the Invention

The present invention relates to a make-up apparatus for liquid type cosmetics, and more particularly, to a make-up apparatus for liquid type cosmetics, which can discharge a proper amount of cosmetics through a pressurization pump and a discharge valve after containing liquid type cosmetics such as lip gross, which can prevent outflow of the cosmetics when it is not used, namely, when a user keeps it as it is or carries it, and which can conveniently apply make-up to a user's skin by pressing the pressurization pump.

2. Background of the Related Art

Conventionally, much studies on make-up apparatuses have been made, but there are still several problems in that a user cannot control and apply make-up of a proper amount to the user's skin, and that cosmetics is leaked out the outside even when the user does not use it.

To solve the above problems, there has been proposed Korean Utility Model Registration No. 0200736 which discloses an improved make-up apparatus for liquid type cosmetics. As shown in FIG. 6, the make-up apparatus for liquid type cosmetics includes a body 10 for containing liquid type cosmetics, a ball mounted on the upper portion of the body 10 for discharging the liquid type cosmetics after the liquid type cosmetics is covered onto the surface of the ball, and supporting means for resiliently pushing the ball, wherein the supporting means includes: a valve chamber 31 mounted inside the body 10 and having a stepped portion 31a formed at the center thereof; a supporter 32 inserted into the valve chamber 31, the supporter 32 having a flange whose upper surface is rested on the stepped portion 31a, a head portion 32b formed on the upper portion thereof for supporting the ball by point contact, and a rod 32c formed on the lower portion thereof; and a spring 33 fitted around the rod 32c of the supporter 32 for pushing the supporter 32 upwardly. The make-up apparatus for liquid type cosmetics is tightly closed up by packing means mounted under the ball so as to ensure its water-tightness, and sufficiently opens an inlet of the make-up apparatus with the ball rolling smoothly to improve its safekeeping efficiency. However, the make-up apparatus for liquid type cosmetics still has the typical problem in that the user cannot easily control and apply make-up of a proper amount.

### SUMMARY OF THE INVENTION

Accordingly, the present invention has been made in view of the above problems, and it is an object of the present invention is to provide a make-up apparatus for liquid type cosmetics, which allows a user to control and apply make-up of a proper amount, which can prevent a random outflow of the cosmetics by discharging the cosmetics only by the user's intention, and which can allow the user to directly apply make-up to the user's face or lips while pressing a pressurization pump.

To achieve the above object, according to the present invention, there is provided a make-up apparatus for liquid type cosmetics includes: a body for containing liquid type cosmetics, the body having a diaphragm, in which a hole is formed, and a groove formed in a side surface thereof; a cap mounted on the lower end of the body, the cap having an air circulation hole; a pressurization pump having a push button, and a push rod, the push button being detachably mounted on the groove of the body, the push rod being located inside the body, having a discharge induction tube therein and a guide part on an end, the guide part sliding contact with the push button; a spring for providing a restoring force to the push button and the push rod; a discharge valve connected with the push rod, the discharge valve having an open-and-shut mechanism for providing the cosmetics only when the external force is applied to the push button; an injection nozzle for providing the cosmetics, which is discharged through the discharge valve, to a brush through a nozzle; a brush and a brush holder for appling the cosmetics supplied by the injection nozzle onto the user's skin; a front end part for supporting the brush by the brush holder while the brush passes through the front end part, the front end part being mounted on the upper end of the body; and a protection cap coupled with the front end part.

It is preferable that the push rod is a two-stepped tube having different diameters, in which the tube of a smaller diameter is the discharge induction tube and the tube of a larger diameter has the guide part formed by tapering a side surface of the outer circumference sliding contact with the push button, and wherein a pressurization member is formed on the lower portion of the push button sliding contact with the tapered guide part.

It is preferable that the make-up apparatus for liquid type cosmetics further includes a supply valve mounted to the discharge induction tube, which is formed inside the push rod, the supply valve having an open-and-shut mechanism and a spring for providing a restoring force to the opening.

It is preferable that the diaphragms formed in a concave shape for inserting an end of the push rod to increase airtightness between the push rod and the partition, and an O-ring is mounted on the outer circumference of the end of the push rod.

It is preferable that the discharge valve has an opening and a spring seated on the tube in order, and a valve tube is mounted on the upper portion of the tube for providing the cosmetics induced through the opening to the injection nozzle.

It is preferable that the make-up apparatus further includes a cosmetics containing part formed integrally with the cap and having a diameter and a length extending to the diaphragm and being inserted into the body.

It is preferable that the make-up apparatus further includes an auxiliary cap inserted into the cosmetics containing part to be in contact with the cap, and an O-ring being mounted on the outer circumference thereof.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view of a make-up apparatus for liquid type cosmetics according to a preferred embodiment of the present invention;

FIG. 2 is a cross-sectional view showing an assembled state of the make-up apparatus of FIG. 1;

FIG. 3 is a partly enlarged sectional view of circumferential parts of a pressurization pump of FIG. 2;

FIG. 4 is an enlarged perspective view of the pressurization pump according to the preferred embodiment of FIG. 1;

FIG. 5 is an enlarged perspective view of a discharge valve according to the preferred embodiment of FIG. 1; and

FIG. 6 is a cross-sectional view of a conventional make-up apparatus for liquid type cosmetics.

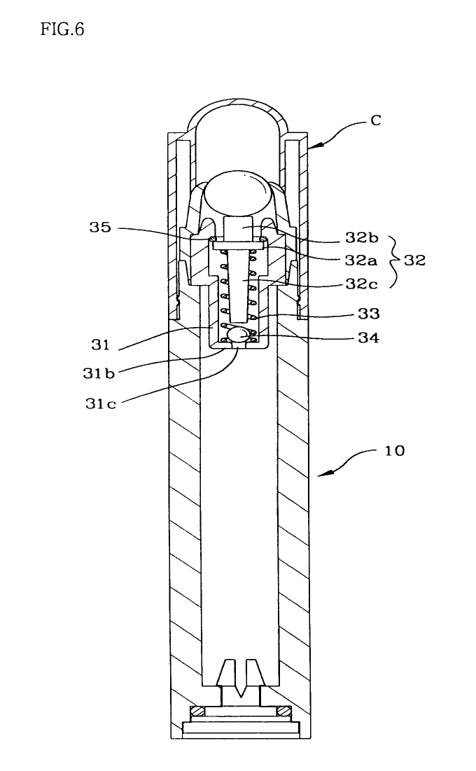

### DETAILED DESCRIPTION OF THE PREFERRED EMBODIMENT

Reference will now be made in detail to the preferred embodiments of the present invention, examples of which are illustrated in the accompanying drawings.

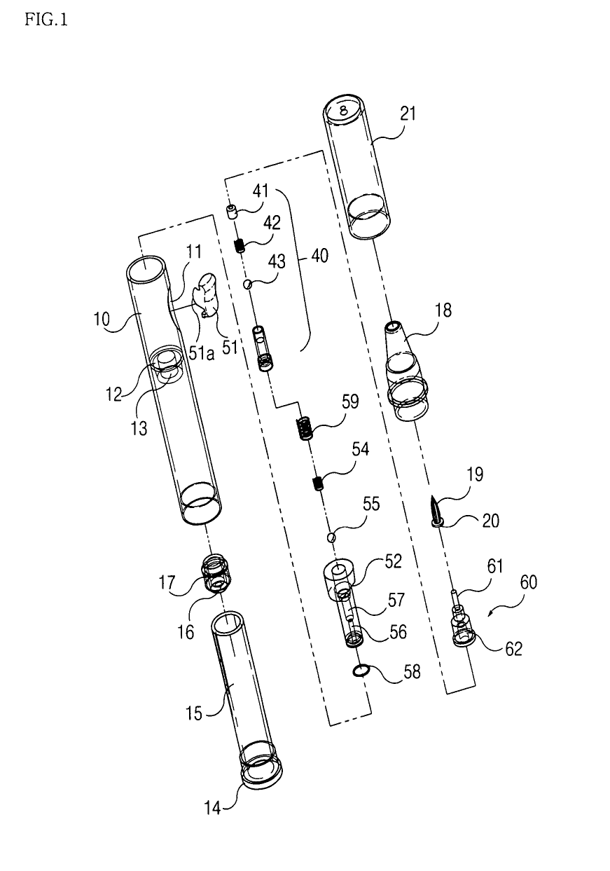

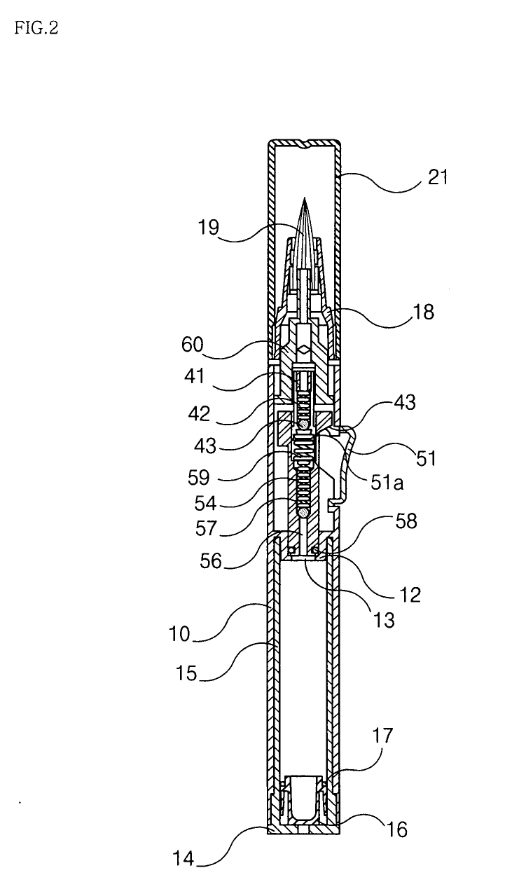

FIG. 1 is an exploded perspective view according to a preferred embodiment of the present invention, and FIG. 2 is a sectional view of an assembled state of the present invention.

As shown in FIGS. 1 and 2, a body 10 includes a groove 11 formed on the outside thereof for mounting a push button 51, and the inside of the body 10 is divided into the upper portion and the lower portion by a diaphragm 12: the upper portion containing a pressurization pump 50; and the lower portion containing cosmetics. The diaphragm 12 has a hole 13 for discharging the cosmetics, which is contained in the lower portion of the body 10 by the pressurization pump 50.

A cap 14 is disposed on the lower end of the body 10, and an air circulation hole.

The pressurization pump 50 includes the push button 51 located on the upper side surface of the body 10, and a push rod 53 located inside the body 10.

The push button 51 is detachably mounted to the groove 11, which is formed in the side surface of the body 10. The push rod 53 includes a guide part 52 formed at an end thereof for sliding contact with the push button 51, and a discharge induction tube 56 formed inside the push rod 54 for guiding flow of cosmetics induced from the lower portion of the body 10. As described above, compared with the conventional push button formed on the rear surface of the body, the push button 51 formed on the side surface of the body 10 can allow the user to more easily grasp the make-up apparatus and press the push button when the user applies make-up to the user's face or lips.

The liquid type cosmetics contained inside the body 10 by the pressurization pump 50 is supplied to a discharge valve 40 through the discharge induction tube 56. The discharge valve 40 is a device for supplying cosmetics to an injection nozzle 60 only when the external force acts to the pressurization pump 50, namely, only when the user intends to apply make-up, and for discharging the cosmetics of a proper amount. The cosmetics controlled to a required amount and supplied by the pressurization pump 50 and the discharge valve 40 is discharged to a brush 19 through the injection nozzle 60. The brush 19 has a brush holder 20, which passes through a front end part 18 and is supported on the front end part 18, the front end part 18 being tightly fit to the upper portion of the body 10. In the present embodiment, the front end part 18 is tightly fit to the body 10, but it would be appreciated that the front end part 18 and the body 10 can be screwed with each other by spiral lines formed on the front end part 18 and the body 10, or coupled with each other by other methods. The brush holder 20 has a hole for inserting a nozzle 61 of the injection nozzle 60. In the present embodiment, the brush 19 is used as a cosmetics applying tool, but it is natural that a ball, a sponge, or other tools may be used as the cosmetics applying tool.

The make-up apparatus for liquid type cosmetics may have a detachable protection cap 21 for safely keeping the cosmetics when it is not used.

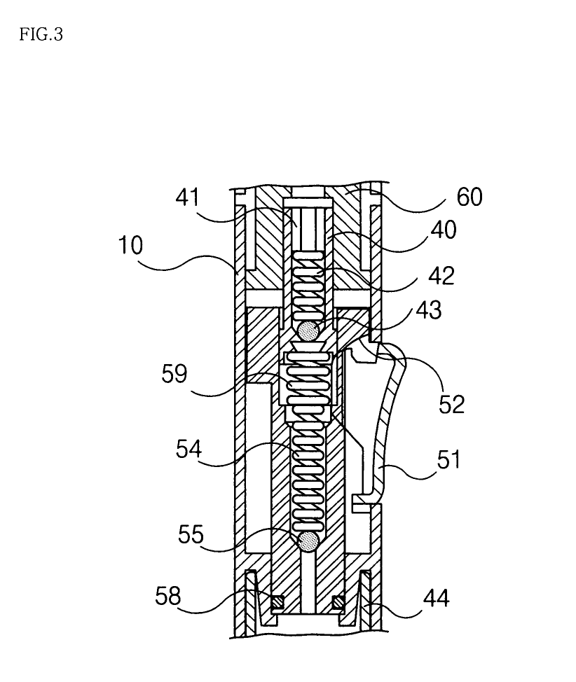

FIG. 3 is a partially enlarged sectional view of circumferential parts of the pressurization pump 50 and the discharge valve 40. The discharge induction tube 56 is in contact with a concave diaphragm 12 of the body 10, and an O-ring 58 is mounted on the diaphragm 12 for maintaining airtightness. The push rod 53, which has a supply valve 57 having an open-and-shut mechanism 55 and a spring 54 for providing a restoring force to the open-and-shut mechanism 55, is located on an end of the discharge induction tube 56. A guide part 52, which is sliding contact with the push button 51, is formed integrally with the upper portion of the push rod 53. Inside the guide part 52, a spring 59 is mounted for providing a restoring force to the push button 51 and the push rod 53, and a hollow portion is formed for inserting the discharge valve 40. Therefore, the spring 54 is interposed between the discharge valve 40 and the guide part 52, and the discharge valve 40 and the guide part 52 come in contact with each other, so that the discharge valve 40 can be inserted into the guide part 52 when the push rod 53 rises by pressing of the push button 51. The discharge valve 40 of a cylindrical tube type, like the supply valve 57, includes an open-and-shut mechanism 43, a spring 42 for providing a restoring force to the open-and-shut mechanism 43, and a valve tube 41 connected to the upper portion thereof for sending the cosmetics induced through the open-and-shut mechanism 43 to the injection nozzle 60. The pressurization pump 50 and the discharge valve 40 will be described in more detail as follows.

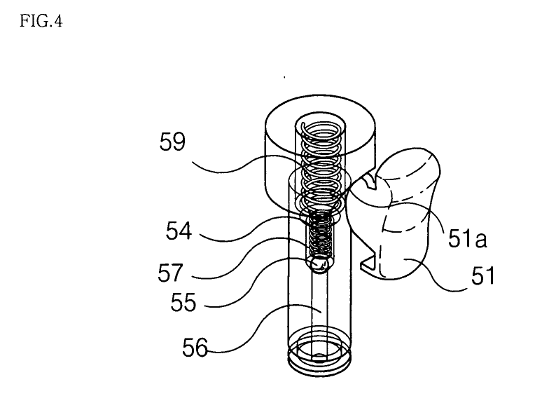

FIG. 4 is an enlarged view of the pressurization pump 50. As shown in FIG. 4, it is preferable that the push rod 53 is a two-stepped tube, which has different inner diameter and outer diameter. The upper portion of the tube, which has a larger diameter, has the guide part 52, which has the same diameter as the tube of a smaller diameter by tapering the side surface of the outer circumference thereof, the guide part 52 being slidably connected with the push button 51. The tube of the smaller diameter located on the lower portion of the push rod 53 has a hollow portion formed therein, which has different diameters. Finally, it is preferable that the push rod includes three hollow portions of different diameters therein, and its diameter is gradually reduced in a downward direction. The smallest hollow portion located at the bottom of the push rod is the discharge induction tube 56 for inducing the cosmetics contained in the body 10 through reciprocating motion of the pressurization pump 50, and the middle hollow portion is the supply valve 57, which includes the open-and-shut mechanism 55 and the spring 54 in order. By the above, the cosmetics can be induced from the body 10 only when the push rod 53 performs reciprocating motion by pressing the pressurization pump 50. The hollow portion of the largest diameter, which is located inside the guide part, is to seat the spring 59 for providing a restoring force to the push button 51 and the push rod 53 after the push button 51 is pressed by the external force.

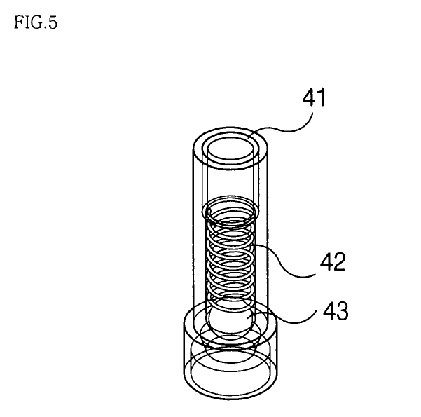

FIG. 5 is an enlarged view of the discharge valve 40. The discharge valve 40 includes the open-and-shut mechanism 43 and the spring 42 for providing a restoring force to the open-and-shut mechanism 43. The discharge valve 40 is opened and induces the cosmetics to the injection nozzle 60 only when the external force acts to the pressurization pump, like the supply valve 57. A valve tube 41 is inserted into the upper end of the discharge valve 40 for discharging the induced cosmetics to the injection nozzle 60 and holding the spring 42.

Furthermore, the cosmetics can be contained in the body 10, but it is preferable that a cosmetics containing part 15 is formed separately from the body 10 to facilitate assembling work and prevent outflow of the cosmetics due to breakage of the body 10. That is, the cosmetics containing part 15, which has diameter and length extending to the diaphragm 12 and being inserted into the body 10, is formed integrally with the cap 14. By forming the separate cosmetics containing part 15, the make-up apparatus has a double type cosmetics containing part 15, thereby protecting the cosmetics without outflow even though the body 10 being in direct contact with the outside is broken or damaged. Moreover, the make-up apparatus can simplify a manufacturing process as the cosmetics containing part 15 is inserted and mounted into the make-up apparatus, which has been manufactured by assembling the components.

If the cosmetics containing part 15 is filled with the liquid type cosmetics after a cylindrically auxiliary cap 16 being in contact with the cap 14 is inserted into the cosmetics containing part 15, the auxiliary cap 16 lowers when the user uses the cosmetics. Additionally, if an O-ring 17 is mounted on the outer circumference of the auxiliary cap 16, the make-up apparatus can be more economical and provide a beautiful appearance as having higher airtightness. Furthermore, to increase airtightness between the push rod 53 and the diaphragm 12, the diaphragm 12 is formed in a concave type to insert an end of the push rod 53, and the O-ring 58 is mounted on the outer circumference of the end of the push rod 53.

According to the preferred embodiment of the present invention, the make-up apparatus for liquid type cosmetics acts as follows.

The liquid type cosmetics is directly contained in the lower portion of the diaphragm or contained in the cosmetics containing part 15. When the contained liquid type cosmetics is not used, it does not flow to the brush 19 as the openings 55 and 43 of the supply valve 57 and the discharge valve 40 are shut and the O-ring 58 is mounted to increase airtightness.

The user pushes the push button 51 to apply make-up to the user's skin. When the push button 51 is pressed, a pressurization member 51a goes into the body 10 while being contact with an inclined surface of the guide part 52, and the push rod 53, which is formed integrally with the guide part performing relative motion, rises upwardly inside the body 10. At this time, when the push rod 53, which is inserted into the concave groove of the diaphragm 12 with higher airtightness by the O-ring 58 mounted on the outer circumference of the lower end of the push rod 53, rises by pressing of the push button 51, the cosmetics goes upwardly along the discharge induction tube 56 connected with the hole 13 of the diaphragm 12. If the external force to the push button 51 is removed, the push rod 53 formed integrally with the guide part by the spring 59, which is inserted into the guide part 52, is lowered to its original position, and thereby, the open-and-shut mechanism 55 of the supply valve is temporarily opened and shut by the cosmetics, which has been already induced. The cosmetics reaches the discharge valve 40 through a flow path, and the opening 43 of the discharge valve is opened by pressure of the cosmetics continuously induced in the above way, so that the cosmetics is discharged to the outside through the injection nozzle 60.

It is preferable that the auxiliary cap 16 is formed on the lower end of the body or the cosmetics containing part before the cosmetics is contained in the body 10 or the cosmetics containing part 15. As the auxiliary cap 16 rises at the same time with the rising of the cosmetics by pressing of the pressurization pump, if the O-ring 17 is mounted on the outer circumference of the auxiliary cap to increase airtightness, the cosmetics contained in the body or the cosmetics containing part can be used nearly 100% without residual of the cosmetics remaining on the inner wall of the body or the cosmetics containing part.

According to the present invention, as the apparatus has the double open-and-shut mechanism of the supply valve and the discharge valve by pressing of the pressurization pump, the make-up apparatus can prevent outflow of the cosmetics when it is not used, thereby providing an excellent airtightness.

Furthermore, the present invention provides an excellent covering capability as it can control the amount of the cosmetics through the pressurization pump.

Particularly, as the push button is formed on the side surface of the body, the user can conveniently use the make-up apparatus by pressing the push button while grasping it.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A make-up apparatus for liquid type cosmetics comprising:
a body for containing liquid type cosmetics, the body having a diaphragm, in which a hole is formed, and a groove formed in a side surface thereof;
a cap mounted on the lower end of the body, the cap having an air circulation hole;
a pressurization pump having a push button, and a push rod, the push button being detachably mounted on the groove of the body, the push rod being located inside the body having a discharge induction tube therein and a guide a part on an end, the guide part sliding contact with the push button;
a spring for providing a restoring force to the push button and the push rod;
a discharge valve connected with the push rod, the discharge valve having an open-and-shut mechanism for providing the cosmetics only when the external force is applied to the push button;
a brush and a brush holder for applying the cosmetics onto a user's skin;
an injection nozzle for providing the cosmetics, which is discharged through the discharge valve, to the brush through a nozzle;
a front end part for supporting the brush holder while the brush passes through the front end part, the front end part being mounted on the upper end of the body; and
a protection cap coupled with the front end part.

2. The make-up apparatus according to claim 1, wherein the push rod is a two-stepped tube having different diameters, in which the tube of a smaller diameter is a discharge induction tube and the tube of a larger diameter has a guide part formed by tapering a side surface of the outer circumference sliding contact with the push button, and wherein a pressurization member is formed on the lower portion of the push button sliding contact with the tapered guide part.

3. The make-up apparatus according to claim 1, further comprising a supply valve mounted to the discharge induction tube, which is formed inside the push rod, the supply valve having an open-and-shut mechanism and a spring for providing a restoring force to the opening.

4. The make-up apparatus according to claim 1, wherein the diaphragm has a concave shape and an O-ring is mounted on the outer circumference of the end of the push rod.

5. The make-up apparatus according to claim 1, wherein the discharge valve has an open-and-shut mechanism and a spring seated on the tube in order, and a valve tube is mounted on the upper portion of the tube for providing the cosmetics induced through the open-and-shut mechanism to the injection nozzle.

6. The make-up apparatus according to claim 1, further comprising a cosmetics containing part formed integrally with the cap, the cosmetics containing part having a diameter and a length extending to the diaphragm and being inserted into the body.

7. The make-up apparatus according to claim 1, further comprising an auxiliary cap inserted into the cosmetics containing part to be in contact with the cap, and an O-ring being mounted on the outer circumference thereof.

8. The make-up apparatus according to claim 2, further comprising a supply valve mounted to the discharge induction tube, which is formed inside the push rod, the supply valve having an open-and-shut mechanism and a spring for providing a restoring force to the opening.

9. The make-up apparatus according to claim 2, wherein the diaphragm has a concave shape and an O-ring is mounted on the outer circumference of the end of the push rod.

10. The make-up apparatus according to claim 2, further comprising an auxiliary cap inserted into the cosmetics containing part to be in contact with the cap, and an O-ring being mounted on the outer circumference thereof.
